(19) United States
(12) Patent Application Publication
(10) Pub. No.: US 2009/0120355 A1
(43) Pub. Date: May 14, 2009

(54) Surface-Treated Doctor Blade

(75) Inventors: Kazuya Urata, Saitama (JP); Nobuo Ijiri, Saitama (JP); Kunio Tachibana, Saitama (JP); Takahito Kaneko, Saitama (JP)

Correspondence Address: DENNIS G. LAPOINTE;LAPOINTE LAW GROUP, PL, PO BOX 1294, TARPON SPRINGS, FL, 34688-1294, US

(73) Assignee: NIHON NEW CHROME CO., LTD., SAITAMA (JP)

(21) Appl. No.: 11/910,748

(22) PCT Filed: Apr. 14, 2006
(86) PCT No.: PCT/JP2006/308379

§ 371 Date: Oct. 5, 2007

(30) Foreign Application Priority Data
Apr. 15, 2005 (JP) 2005-118520

(51) Int. Cl. B05C 11/02

(52) U.S. Cl. 118/100

(57) ABSTRACT

The surface-treated doctor blade having nickel-phosphorus-based alloy plating which does not include irregularities of planar diameter exceeding 50 μm at least at the blade edge end can have an improved conformability of blade edge and at the same time improved wear resistance of the blade edge, thereby enabling reduction in exchange frequency of the blades. Moreover, it is preferable that the plating include 20 or less irregularities of planar diameter more than 30 μm per 1 m in the longitudinal direction, more preferably the plating includes 10 or less irregularities of planar diameter more than 20 μm per 1 m in the longitudinal direction, particularly preferably the plating includes 5 or less irregularities of planar diameter more than 10 μm per 1 m in the longitudinal direction.

### RELATED APPLICATIONS

This application is a national stage application under 35 USC 371 of international application PCT/JP2006/308379 filed Apr. 14, 2006, which claims priority from Japanese Patent Application JP 2005-118520 filed Apr. 15, 2005.

### TECHNICAL FIELD

The present invention relates to a surface-treated doctor blade. More specifically, the present invention relates to a surface-treated doctor blade, which can reduce idling which is conducted for adjusting contact between the blade edge and a cylinder after replacing a doctor blade and is excellent in wear resistance of the blade edge.

### BACKGROUND ART

In gravure printing (intaglio printing), as shown in FIG. 1 and FIG. 2, (in order to facilitate comprehension, the blade is described with an extreme exaggeration in both FIG. 1 and FIG. 2, out of proportion to the cylinder), a cylinder (1) having a large number of depressions called “cells” (not shown in the Figures) formed on the surface which respond to images is used and, onto the rotating surface of the cylinder, a doctor blade (2) made of steel or stainless steel is pressed with a predetermined pressure to thereby scrape off the ink (3) attached on non-image portions of the printed surface. This doctor blade not only completely removes the ink from non-image portions but also has a function of leaving a predetermined amount of ink on the image portion. Therefore, contact pressure between the cylinder and the doctor blade must be always kept constant and the blade edge is required to have wear resistance. Heretofore, a variety of surface-treated doctor blades have been used.

For example, as surface-treated doctor blade using nickel-base plating, doctor blades having composite plating (5) where SiC fine particles are dispersed in nickel-base metal (more specifically, nickel-phosphorus alloy) matrix are widely used. However, such a surface-treated doctor blade whose blade edge end (6) is completely covered with plating as shown in FIG. 2 readily causes printing defects such as streaking and fogging when printing is performed immediately after replacing the blade. In order to avoid printing defects, actual printing is usually conducted after idling is conducted for 30 to 60 minutes to thereby make the contact between the cylinder and the blade in better conformity. However, such an approach includes time loss due to the idling and the printing efficiency is very low. Further, the printing method involves a problems that the cylinder may be damaged or that the blade may be worn disproportionately during the idling. Hereinafter, properties coping with these problems are collectively referred to “conformability of the blade edge”.

The present inventors previously proposed a surface-treated doctor blade comprising a surface treating film consisting of a specific nickel-base plating as the first layer and a low-surface-energy film formed thereon as the second layer with at least a part of blade substrate at the blade edge being exposed, in JP 2003-225988 A (EP1469996).

### DISCLOSURE OF THE INVENTION

Although the proposed blade has an effect of improving conformability of the blade edge, abrasion rate is high since the blade substrate is exposed at the blade edge end contacting the cylinder, as compared with a surface-treated doctor blade whose substrate is not exposed. Accordingly, when simply compared with respect to wear resistance of blade edge, the proposed blade is not so good. Therefore, in normal printing which does not require high printing properties, since the abrasion rate of the blade edge is inversely proportional to the printing amount in continuous printing, there is a problem that a blade whose blade edge easily wears off (i.e., abrasion rate is high) is high in its exchange frequency (i.e., the blade life is short) and is inferior in property for continuous printing.

Accordingly, the object of the present invention is, by solving the above problems, to provide a surface-treated doctor blade, which is improved in conformability of the blade edge and at the same time in wear resistance of the blade edge, and which enables reduction in exchange frequency of blades.

The present inventors have made intensive studies on techniques other than that described in JP 2003-225988 A for the purpose of improving conformability of the blade edge in gravure printing and as a result, have found that the shape (irregularities) of the plating surface of the blade edge greatly dominates conformability of the blade edge and that a surface-treated doctor blade not having irregularities larger than a certain dimension can have a greatly improved conformability of the blade edge without deteriorating wear resistance.

That is, the present invention consists of the following items.
[1] A surface-treated doctor blade comprising nickel-phosphorus-based alloy film, which does not have irregularities of planar diameter exceeding 50 μm at least at the blade edge end.
[2] The surface-treated doctor blade described in [1] above, having on the nickel-phosphorus-based alloy film a liquid film layer containing at least one atom selected from the group consisting of sulfur, nitrogen and phosphorus.
[3] The surface-treated doctor blade described in [2] above, wherein the thickness of the liquid film layer is less than 1 μm.
[4] The surface-treated doctor blade described in [1] above, wherein at least at the blade edge end, the number of irregularities having a planar diameter more than 30 μm but 50 μm or less is 20 or less per 1 m in the longitudinal direction of the lengthy blade.
[5] The surface-treated doctor blade described in [2] above, wherein at least at the blade edge end, the number of irregularities having a planar diameter more than 30 μm but 50 μm or less is 20 or less per 1 m in the longitudinal direction of the lengthy blade.
[6] The surface-treated doctor blade described in [1] above, wherein at least at the blade edge end, the number of irregularities having a planar diameter more than 20 μm but 50 μm or less is 10 or less per 1 m in the longitudinal direction of the lengthy blade.
[7] The surface-treated doctor blade described in [2] above, wherein at least at the blade edge end, the number of irregularities having a planar diameter more than 20 μm but 50 μm or less is 10 or less per 1 m in the longitudinal direction of the lengthy blade.
[8] The surface-treated doctor blade described in [1] above, wherein at least at the blade edge end, the number of irregularities having a planar diameter more than 10 μm but 50 μm or less is 5 or less per 1 m in the longitudinal direction of the lengthy blade.
[9] The surface-treated doctor blade described in [2] above, wherein at least at the blade edge end, the number of irregularities having a planar diameter more than 10 μm but 50 μm or less is 5 or less per 1 m in the longitudinal direction of the lengthy blade.

### BRIEF DESCRIPTION OF DRAWINGS

FIG. 1 is a schematic view showing gravure printing (intaglio printing) using a doctor blade.

FIG. 2 is a sectional view of a blade edge end of a doctor blade.

FIG. 3 is an explanatory drawing illustrating the specific shape of the edge end of the blade.

FIG. 4 is a sectional view of a blade edge end of the doctor blade prepared in Comparative Example 2.

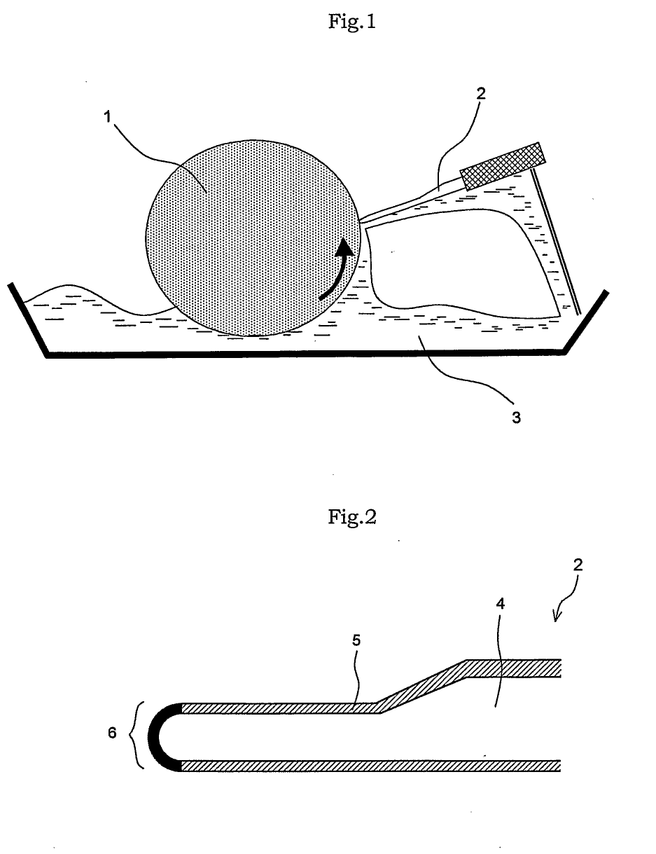

### BEST MODE FOR CARRYING OUT THE INVENTION

Hereinafter, the present invention is described in detail.

As doctor blade substrate used in the present invention, any known steel or stainless-steel substrate which is used in printing or coating may be employed.

Further, base material for doctor blade is usually processed, for example to form a step thereon, so that the side edge to be a blade edge can be a thin blade edge. The variety of edge shapes includes parallel, bevel, round and keen, and any shape may be employed. Moreover, either a single-edged type which has one side processed to be a blade edge or a both-edged type which has both sides processed to be blade edges can be employed according to use.

In the present invention, blade substrates of any size may be employed without limitation. For example, a representative example of blade substrate consists of steel plate of 0.15 to 0.6 mm thick and 40 to 60 mm wide.

The most distinguishing feature of the surface-treated doctor blade of the present invention is that the blade does not have irregularities of planar diameter of larger than 50 μm at least at the blade edge end.

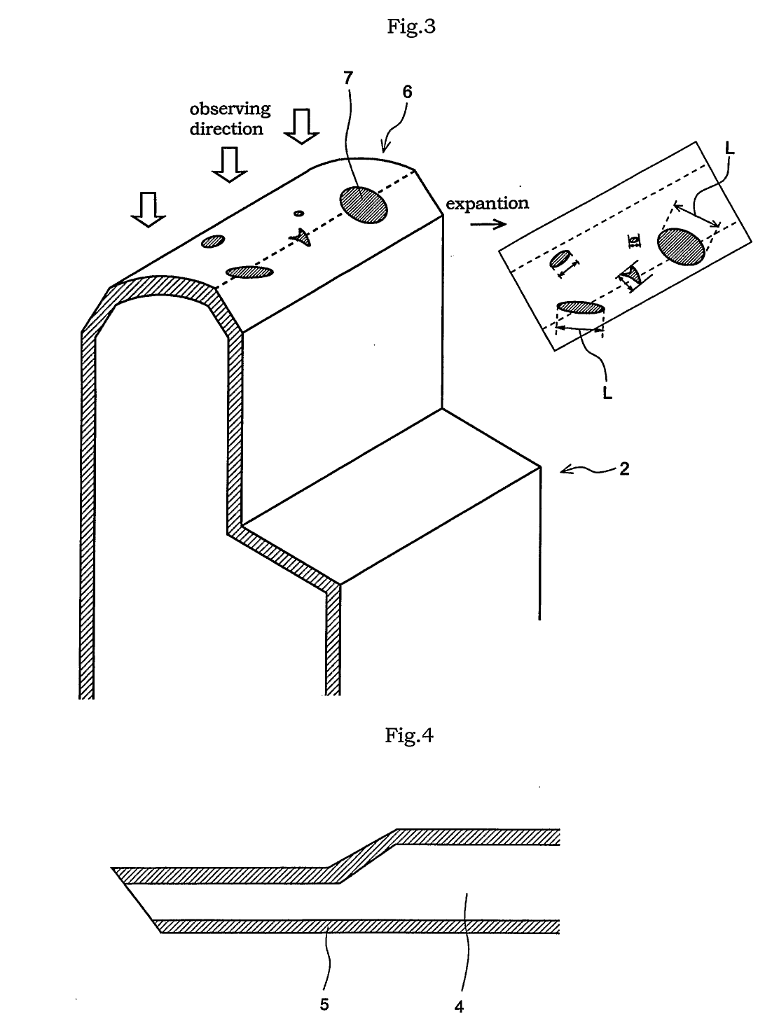

The term “blade edge end” used herein means the edge end surface (6) ranging from one surface (upper surface) of the blade edge in the vicinity of the blade edge end to the other surface (lower surface) of the blade edge via the edge end, as shown in FIGS. 2 and 3. In the present invention, among the irregularities (7), irregularities of a planar diameter exceeding 50 μm are not allowed to be present on the edge end surface.

As shown in FIG. 3, the term “irregularities of a planar diameter exceeding 50 μm” does not refer to the three-dimensional size such as the depth of irregularities in the thickness direction from the plating surface of the blade edge end, but always refers to the two-dimensional size in the planar direction of the plating surface of the blade edge end. In a case where an irregularity has a complicated shape, the longer diameter (L) is referred to.

In the present invention, presence or absence of irregularities can be determined by observing the plating surface of the blade edge end through optical microscope in the direction the arrows indicate in FIG. 3. Further, the term “irregularities” used herein means irregularities detectable by optical microscope.

More specifically, the term “irregularities” means dents and convexes each having its maximum depth or height of 50% or more of the average plating film thickness. The planar diameter of each of the irregularities is measured on the portion having 10% or more of the average plating film thickness. The measurement can be conducted, for example, by forming a three-dimensional figure of the plating surface with laser microscope or by directly observing a cross-section surface of the blade with optical microscope or electronic microscope.

When even a single irregularity exceeding 50 μm is present, a long-time idling is required to adapt the blade edge. Accordingly, wear of the blade edge due to such an idling increases (i.e., wearing the blade edge to no purpose), and as a result, the effective blade edge which can work for actual printing becomes short, which leads to decrease in printing amount achieved by continuous printing.

Furthermore, in addition to the above requirements of the present invention, the number of irregularities of a size exceeding 30 μm but 50 μm or less present on the plating surface is preferably 20 or less per 1 m of the blade, more preferably 10 or less. Even more preferably, the number of irregularities of a size exceeding 20 μm but 50 μm or less present on the plating surface is preferably 10 or less per 1 m of the blade, and still more preferably, 5 or less. Particularly preferably the number of irregularities of a size exceeding 10 μm but 50 μm or less present on the plating surface is preferably 5 or less per 1 m of the blade.

With respect to irregularities of a size out of the range specified in the present invention, there is no limitation.

Thus, by forming the plating surface of the blade edge end contacting the cylinder into a specific shape, conformability of the blade edge can be improved. Further, in the present invention, the surface of the blade edge end has a plating thereon, wear resistance of the blade edge does not deteriorate as does in JP 2003-225988 A.

The plating used in the present invention is nickel-phosphorus-based alloy plating, preferably nickel-phosphorus-based dispersion plating wherein in nickel-phosphorus-based alloy matrix, at least one kind of particles selected from the group consisting of organic resin particles constituted by fluorine-based resin, Al₂O₃, Cr₂O₃, Fe₂O₃, TiO₂, ZrO₂, ThO₂, SiO₂, CeO₂, BeO₂, MgO, CdO, diamond, SiC, TiC, WC, VC, ZrC, TaC, Cr₃C₂, B₄C, BN, ZrB₂, TiN, Si₃N₄, WSi₂ and the like is dispersed.

Among these particle-dispersed nickel-phosphorus-based platings, those having ceramic particles dispersed therein, particularly those having SiC particles dispersed therein is preferred.

The particle size of dispersed particles used therein is preferably 0.05 to 5 μm. If the particle size is less than 0.05 μm or exceeds 5 μm, wear resistance or adhesion of plating deteriorates. The more preferable particle size is 0.1 to 2 μm. The most preferred is 0.15 to 1 μm.

The amount of the dispersed particles contained in the plating is preferably from 0.5 to 40 vol %. If the amount is less than 0.5 vol %, the effect of improving wear resistance cannot be obtained. If the amount exceeds 40 vol %, adhesion property of the plating is deteriorated, which is not preferred. More preferred is from 3 to 30 vol %, still more preferred is 5 to 25 vol %.

The phosphorus amount contained in the nickel-phosphorus-based alloy plating layer is preferably from 5 to 10 mass %, more preferably from 7 to 9 mass %.

In the doctor blade of the present invention, it is preferable that the surface hardness of the surface treated portion of the blade edge, as measured by Vickers hardness (Hv) method, be from 400 to 1,500. If the Vickers hardness is less than 400, wear resistance deteriorates. If it exceeds 1500, problems will occur that conformability of the blade edge deteriorates and that plating is brittle and easy to be peeled off, whereby the printing surface of the cylinder is damaged, which leads to printing defects. From the standpoint of the conformability and wear resistance of the blade edge, particularly preferred Vickers hardness (Hv) is from 700 to 950.

In the present Description, Vickers hardness (Hv) is a value measured and defined according to JIS Z 2251 microhardness testing method. (Regarding the test load, a load of less than 50 gf may be appropriately selected and used according to the film thickness.)

In the present invention, the film thickness of the nickel-phosphorus-based alloy plating layer is preferably 3 to 20 μm, more preferably 3 to 10 μm. A known measurement method can be employed for measurement of the plating thickness. Examples of known measurement methods include: (1) a method in which film thickness is measured by using a fluorescent X-ray measurement apparatus, (2) a method in which the surface treating film is peeled off by means of peeling agent solution to measure the film thickness based on the difference in weight before and after peeling, and (3) a method in which the vertical section is observed by an optical microscope or an electronic microscope to measure the plating thickness.

In the present invention, by further forming a liquid film layer containing at least one atom selected from the group consisting of sulfur, nitrogen and phosphorus on the plating layer, wear resistance and corrosion resistance can be further enhanced. The thickness of this film formed on the plating layer is preferably less than 1 μm, more preferably less than 0.5 μm.

As described above, the surface-treated doctor blade of the present invention can include an effect of improving both properties of the conformability and wear resistance of the blade edge by having the plating surface of the blade edge end contacting the cylinder formed into a specific shape.

The surface-treated blade of the present invention can be produced by using known methods, however, it is necessary to strictly manage the process of the surface treatment.

For example, the surface-treated blade of the present invention can be produced through the sequence of steps: degreasing→rinsing→activation→rinsing→nickel→phosphorus→based alloy plating→rinsing→drying→annealing→blade edge checking (if necessary, →plating surface adjustment by polishing the blade edge plating surface for the purpose of forming the plating surface into a desired shape). Further, plating surface adjustment by polishing of the blade edge plating surface may be included during the process, or annealing step may be omitted. Also, the step of checking the blade edge (if necessary, including plating surface adjustment step by polishing the blade edge plating surface for the purpose of forming the plating surface into a desired shape) may be conducted before annealing step.

In the series of the plating steps, it is necessary to perform the process management in consideration of, for example, the following points. By totally managing the process including these points, irregularities present on the blade edge end can be easily formed into specific shape defined in the present invention.
(1) The acid concentration in the activation step is controlled to a predetermined concentration and impregnation is not continued long. That is, generation of irregularities on the plating due to roughening of base material is prevented.
(2) Rinsing step and plating step are conducted immediately after the activation step, so that the time period when the blade is in the air (intervals between the steps) may be short. That is, generation of irregularities on the plating due to corrosion and rusting of the material is prevented.
(3) In a case where sodium hydroxide is used as pH adjuster for the plating solution, the pH adjuster is added during intense stirring, or the pH adjuster is diluted to a thin concentration in advance before added, to prevent generation of nickel hydroxide through reaction with nickel ions.
(4) The plating solution is sufficiently filtered, so that insoluble contents like dusts, polishing dusts and peeled-off pieces of the plating film present in the plating solution do not codeposit.
(5) The pH of the plating solution is strictly controlled in order to prevent the pH from getting out of the control range and thereby prevent generation of hydrated metal salt.

Further, after applying the plating, blade edge checking step is provided before or after annealing step, to examine the plating surface. In a case where irregularities having a size exceeding the range specified in the present invention are present, the blade edge is polished with a buff, a sand paper or the like either automatically or by hand, to thereby adjust the shape of the blade edge surface.

Examples of method for applying plating usable if the present invention include known plating techniques such as electric plating and electroless plating.

In the present invention, for the purpose of enhancing adhesion between the blade substrate and plating layer or accelerating deposit of the plating film, a base plating of nickel-based plating or copper-based plating may be provided as base treatment before the main plating. Particularly, in a case where a stainless material is used as blade substrate, nickel-based strike plating is effective.

In the mode for carrying out the present invention, there is no limitation on treatments to be made to portions other than blade edge portion, as far as at least the edge end of the doctor blade is treated according to the present invention.

The surface-treated doctor blade obtained according to the present invention can be employed in printing such as gravure printing, and further can be also employed as a coating, a member for removing toner residue mounted in image formation apparatus or the like. Furthermore, ink or paint used in printing or coating may be either oil-based or water-based. Moreover, types of inking apparatus in printing machine are classified into those of dipping type and those of furnisher roller type. The blade of the present invention can be used in any type as far as the inking method employs a blade.

### EXAMPLES

The present invention will hereinafter be described with reference to Examples and Comparative Examples, however the present invention should not be limited to the description hereinafter. In the Examples and Comparative Examples, the degree of surface hardness, film thickness, and surface shape of the surface-treated doctor blade were measured by the following methods.

### [Surface Hardness (Vickers Hardness)]

Hardness was measured on five points of the surface and the average value was employed as Vickers hardness.
Measuring apparatus: HMV-2000 manufactured by Shimadzu Corporation;
Measurement condition: a test load of 25 gf and a retention time of 10 seconds.

### [Film Thickness]

The section of the blade edge was observed by an optical microscope to measure the film thickness.

### [Surface Shape]

By observing the surface of the blade edge end with a laser microscope and an optical microscope, the number of irregularities each having its maximum depth or height of 50% or more of the average plating film thickness was counted and with respect to the counted irregularities, the planar diameter of the portion where the depth or height in each irregularity was 10% or more of the average plating film thickness was measured.

### [Surface Treatment Method]

### Plating Step:

A single-and-parallel-edged steel substrate for doctor blade (steel strip having a total length of 50 m) having a plate width of 50 mm, a plate thickness of 0.15 mm, a blade edge width of 1.4 mm and a blade edge end thickness of 0.07 mm was spirally taken up on a reel together with a spacer consisting of a metal steel strip which had the surface roughened by embossing treatment, and in the state in which it was kept wound around the reel, it was immersed for 15 minutes in an alkali degreasing solution (Pakuna RT-T: 60 g/L, manufactured by Yuken Industry Co., Ltd.) of 50° C. After being washed in water, it was subjected to a hydrochloric acid activation treatment in a hydrochloric acid activation liquid for 15 minutes, and was then further washed in water. Thereafter, it was immersed in an electroless Ni plating solution in which SiC particles having an average particle size of 0.5 μm were dispersed (plating solution manufactured by Japan Kanigen Co., Ltd.; Sumer SC-80-1: 20 vol %, Sumer SC-80-4; 2 vol %) at 87° C. until a predetermined plating thickness was attained to effect nickel-composite plating containing SiC. After being washed in water, the specimen was dried. Thereafter, the spacer and the blade were unwound and separated to obtain a blade 1 having an SiC-particle-containing nickel-phosphorus-based composite (Ni—P—SiC) plating.

### Surface Adjustment Step:

Buff polishing was performed on the plated blade 1 to completely remove the plating residues or the like from the surface, thereby obtaining a plated blade 2.

### Post-Treatment Steps:

Annealing was performed on the above-described plated blade 2 at 300° C. for an hour, and then the blade was cut at every two meters in rectangles, so that rectangular blades were obtained. Then, according to the methods described in Examples 1 and 2 and Comparative Examples 1 and 2, surface-treated blades were produced.

### EXAMPLE 1

The blade edge end surface of each of rectangular plated blades was observed with an optical microscope and while polishing it with a buff or sandpaper when necessary, only the blades whose blade edge end had 10 or less irregularities of more than 30 μm but 50 μm or less on its surface per 1 m but did not have any irregularities of more than 50 μm were sorted out to be surface-treated doctor blades of Example 1.

Surface Hardness (Hv), film thickness, conformability of the blade edge and wear resistance were measured and evaluated, and the results were collectively shown in Table 1. The methods for evaluation conformability of the blade edge and wear resistance were as follows.

### (1) Conformability of the Blade Edge

Idling of a printing machine having a blade obtained in Example 1 mounted therein was conducted with an oil-base ink. The conformability of the blade edge was evaluated with the time period immediately after starting the idling until the machine could properly operate to produce prints without printing defects such as streaking, fogging, fading and blurring.
⊚: less than 5 minutes
◯+: 5 minutes or more and less than 10 minutes
◯: 10 minutes or more and less than 30 minutes
Δ: 30 minutes or more and less than 60 minutes
x: 60 minutes or more

### (2) Wear Resistance

By using a printing machine having a blade obtained in Example 1 mounted therein, 3000 m-printing was conducted. Subsequently, the blade was detached from the printing machine, and the length of the blade edge end was measured. The wear degree of the blade was evaluated by the following calculation.

[worn-away length]=[initial blade edge length]−[blade edge length after the test]

The evaluation criteria were as follows.

### [Evaluation Criteria]

⊚: worn-away length of less than 1 mm
◯: worn-away length of 1 mm or more but less than 1.5 mm
x: worn-away length of 1.5 mm or more

### EXAMPLE 2

The blade edge end surface of each of rectangular plated blades was observed with an optical microscope and while polishing it with a buff or sandpaper when necessary, only the blades whose blade edge end had 3 or less irregularities of more than 10 μm but 50 μm or less on its surface per 1 m but did not have any irregularities of more than 50 μm were sorted out to be surface-treated doctor blades of Example 2.

Surface Hardness (Hv), film thickness, conformability of the blade edge and wear resistance were measured and evaluated in the same manner as in Example 1, and the results were collectively shown in Table 1.

### EXAMPLE 3

The blade edge end surface of each of rectangular plated blades was observed with an optical microscope and while polishing it with a buff or sandpaper when necessary, only the blades whose blade edge end had 11 or more but 20 or less irregularities of more than 30 μm but 50 μm or less on its surface per 1 m but did not have any irregularities of more than 50 μm were sorted out to be surface-treated doctor blades of Comparative Example 3.

Surface Hardness (Hv), film thickness, conformability of the blade edge and wear resistance were measured and evaluated in the same manner as in Example 1, and the results were collectively shown in Table 1.

### COMPARATIVE EXAMPLE 1

The blade edge end surface of each of rectangular plated blades was observed with an optical microscope and only the blades whose blade edge end had 1 or more irregularities of more than 50 μm other than the blades of Examples 1, 2 and 3 were sorted out to be surface-treated doctor blades of Comparative Example 1.

Surface Hardness (Hv), film thickness, conformability of the blade edge and wear resistance were measured and evaluated in the same manner as in Example 1, and the results were collectively shown in Table 1.

### COMPARATIVE EXAMPLE 2

The blade edge end of each of rectangular plated blades was polished as shown in FIG. 4 (FIG. 3 of Patent Document 1) to thereby remove the alloy plating film only from the blade edge end, to prepare surface-treated doctor blades of Comparative Example 2.

Surface Hardness (Hv), film thickness, conformability of the blade edge and wear resistance were measured and evaluated in the same manner as in Example 1, and the results were collectively shown in Table 1.

TABLE 1

| | | Plating film | | |
|---|---|---|---|---|
| | Surface | thickness | Conformability | Wear |
| No | hardness (Hv) | (μm) | of blade edge | resistance |
| Example 1 | 850 | 6 | ◯+ | ⊚ |
| Example 2 | 850 | 6 | ⊚ | ⊚ |
| Example 3 | 850 | 6 | ◯ | ⊚ |
| Comparative | 850 | 6 | X | ◯ |
| Example 1 | | | | |
| Comparative | 850 | 6 | ◯ | X |
| Example 2 | | | | |

1. A surface-treated doctor blade comprising nickel-phosphorus-based alloy film, which does not have irregularities of planar diameter exceeding 50 μm at least at the blade edge end.

2. The surface-treated doctor blade as claimed in claim 1, having on the nickel-phosphorus-based alloy film a liquid film layer containing at least one atom selected from the group consisting of sulfur, nitrogen and phosphorus.

3. The surface-treated doctor blade as claimed in claim 2, wherein the thickness of the liquid film layer is less than 1 μm.

4. The surface-treated doctor blade described in claim 1, wherein at least at the blade edge end, the number of irregularities having a planar diameter more than 30 μm but 50 μm or less is 20 or less per 1 m in the longitudinal direction of the lengthy blade.

5. The surface-treated doctor blade as claimed in claim 2, wherein at least at the blade edge end, the number of irregularities having a planar diameter more than 30 μm but 50 μm or less is 20 or less per 1 m in the longitudinal direction of the lengthy blade.

6. The surface-treated doctor blade as claimed in claim 1, wherein at least at the blade edge end, the number of irregularities having a planar diameter more than 20 μm but 50 μm or less is 10 or less per 1 m in the longitudinal direction of the lengthy blade.

7. The surface-treated doctor blade as claimed in claim 2, wherein at least at the blade edge end, the number of irregularities having a planar diameter more than 20 μm but 50 μm or less is 10 or less per 1 m in the longitudinal direction of the lengthy blade.

8. The surface-treated doctor blade as claimed in claim 1, wherein at least at the blade edge end, the number of irregularities having a planar diameter more than 10 μm but 50 μm or less is 5 or less per 1 m in the longitudinal direction of the lengthy blade.

9. The surface-treated doctor blade as claimed in claim 2, wherein at least at the blade edge end, the number of irregularities having a planar diameter more than 10 μm but 50 μm or less is 5 or less per 1 m in the longitudinal direction of the lengthy blade.
